(19) United States
(12) Patent Application Publication
(10) Pub. No.: US 2011/0310907 A1
(43) Pub. Date: Dec. 22, 2011

(54) SYSTEMS AND METHODS FOR IMPLEMENTING A CONTROL PLANE IN A DISTRIBUTED NETWORK

(75) Inventors: Philippe Klein, Jerusalem (IL); Avraham Kliger, Ramat Gan (IL); Yitshak Ohana, Givat Zeev (IL)

(73) Assignee: Broadcom Corporation, Irvine, CA (US)

(21) Appl. No.: 13/152,454

(22) Filed: Jun. 3, 2011

Related U.S. Application Data
(60) Provisional application No. 61/355,274, filed on Jun. 16, 2010.

(51) Int. Cl. H04L 12/56

(52) U.S. Cl. 370/401

(57) ABSTRACT

Systems and methods for emulating the bridging of control packets of a first network through a second network. Control packets may be Ethernet control packets instantiating a stream through the emulated bridge. One such protocol is the Institute for Electrical and Electronics Engineers (IEEE) 802.1Q protocol. One second network may be a MoCA 2.0 network or a Power Line Communication (PLC) network or any other suitable network. Control packets may be encapsulated as unicast packets according the second network and sent to a control plane node. The encapsulated unicast packets may be indentified and decapsulated by the control plane node. The control plane node may verify access to resources required by the control packet of the emulated bridge. The control plane may send encapsulated packets to the egress nodes of the second network that have sufficient resources to satisfy the control packet requirements. Each egress nodes receiving the encapsulated packets may decapsulate the control packet and sent it to a first network device.

### CROSS-REFERENCED TO RELATED APPLICATION

This application is a non-provisional of U.S. Provisional Patent No. 61/355,274, filed Jun. 16, 2010, entitled “MSRPDU Handling in MoCA”, which is incorporated by reference herein in its entirety.

### FIELD OF TECHNOLOGY

The present invention relates generally to information networks and specifically to the bridging of information according to a first network—e.g., the Institute for Electrical and Electronics Engineers (IEEE) 802.1Q protocol—via a second network—e.g., a MoCA network or a Power Line Communication (PLC) network or any other suitable network.

### BACKGROUND

Home network technologies using coax are known generally. The Multimedia over Coax Alliance (MoCA™), at its website mocalliance.org, provides an example of a suitable specification (MoCA 2.0) for networking of digital video and entertainment through existing coaxial cable in the home which has been distributed to an open membership. The MoCA 2.0 specification is incorporated by reference herein in its entirety.

Home networking over coax taps into the vast amounts of unused bandwidth available on the in-home coax. More than 70% of homes in the United States have coax already installed in the home infrastructure. Many have existing coax in one or more primary entertainment consumption locations such as family rooms, media rooms and master bedrooms - ideal for deploying networks. Home networking technology allows homeowners to utilize this infrastructure as a networking system and to deliver other entertainment and information programming with high QoS (Quality of Service).

The technology underlying home networking over coax provides high speed (270 mbps), high QoS, and the innate security of a shielded, wired connection combined with state of the art packet-level encryption. Coax is designed for carrying high bandwidth video. Today, it is regularly used to securely deliver millions of dollars of pay per view and premium video content on a daily basis. Home networking over coax can also be used as a backbone for multiple wireless access points used to extend the reach of wireless network throughout a consumer's entire home.

Home networking over coax provides a consistent, high throughput, high quality connection through the existing coaxial cables to the places where the video devices currently reside in the home. Home networking over coax provides a primary link for digital entertainment, and may also act in concert with other wired and wireless networks to extend the entertainment experience throughout the home.

Currently, home networking over coax complements access technologies such as ADSL and VDSL services or Fiber to the Home (FTTH), that typically enter the home on a twisted pair or on an optical fiber, operating in a frequency band from a few hundred kilohertz to 8.5 MHz for ADSL and 12 Mhz for VDSL. As services reach the home via xDSL or FTTH, they may be routed via home networking over coax technology and the in-home coax to the video devices. Cable functionalities, such as video, voice and Internet access, may be provided to homes, via coaxial cable, by cable operators, and use coaxial cables running within the homes to reach individual cable service consuming devices locating in various rooms within the home. Typically, home networking over coax type functionalities run in parallel with the cable functionalities, on different frequencies.

It would be desirable to utilize a MoCA device for many purposes. One desirable purpose would be the transmission of IEEE 802.1Q packets, where a MoCA network may serves as a bridge. For the purpose of this application, the term “node” may be referred to alternatively herein as a “module.”

### SUMMARY

A system and/or method for enabling a MoCA network or any other suitable network—e.g., a powerline communication (PLC) network—for use as an Ethernet bridge is provided. The Ethernet protocol may be used to create various network topologies including the bridging, or connecting of two Ethernet devices. An Ethernet device may also be an Ethernet bridge. Particular protocols from the IEEE provide Multicast services over Ethernet—e.g., IEEE 802.1Q. Such services may require the transmission of control packets.

MoCA and PLC networks are Coordinated Shared Networks (CSN). A CSN is a time-division multiplexed-access network in which one of the nodes acts as the Network Coordinator (NC) node, granting transmission opportunities to the other nodes of the network. A CSN network is physically a shared network, in that a CSN node has a single physical port connected to the half-duplex medium, but is also a logically fully-connected one-hop mesh network, in that every node could transmit to every other node using its own profile over the shared medium. CSNs support two types of transmissions: unicast transmission for node-to-node transmission and multicast/broadcast transmission for one-node-to-other/all-nodes transmission. Each node-to-node link has its own bandwidth characteristics which could change over time due to the periodic ranging of the link. The multicast/broadcast transmission characteristics are the minimal common characteristics of multiple/all the links of the network.

An embodiment of the present invention emulates an Ethernet bridge via a MoCA network, or indeed any CSN network).

### BRIEF DESCRIPTION OF THE DRAWINGS

The objects and advantages of the invention will be apparent upon consideration of the following detailed description, taken in conjunction with the accompanying drawings, in which like reference characters refer to like parts throughout, and in which:

FIG. 1A is a schematic of a network which may include an Ethernet bridge;

FIG. 1B is a schematic of a network where a MoCA network may serve as an Ethernet bridge;

FIG. 2A is a schematic of a an Ethernet bridge which may generate packet flooding;

FIG. 2B is a schematic of a an Ethernet bridge which may propagate multicast packets;

FIG. 3A is a schematic of a MoCA network which may emulate an Ethernet bridge generating packet flooding;

FIG. 3B is a schematic of a MoCA network which may emulate an Ethernet bridge propagating multicast packets;

FIG. 4 is a schematic of a some network layers of a MoCA network;

FIG. 5 is a schematic of an example of the messaging implementing a protocol which process a control packet querying bandwidth for a stream;

FIG. 6 is a schematic of an example of the messaging implementing a protocol which process a control packet reserving bandwidth for a stream;

FIG. 7 is a flowchart 700 showing an embodiment of the steps for the incoming processing an Ethernet multicast control packet for transit through a MoCA network which emulates an Ethernet bridge;

FIG. 8 is a flowchart 800 showing the steps for control plane processing of an Ethernet multicast packet transiting a MoCA network which emulates an Ethernet bridge; and

FIG. 9 is a schematic of packet processing showing the steps for the transit of an Ethernet multicast packet through a MoCA network which emulates an Ethernet bridge.

### DETAILED DESCRIPTION OF THE DISCLOSURE

In the following description of the various embodiments, reference is made to the accompanying drawings, which form a part hereof, and in which is shown by way of illustration various embodiments in which the invention may be practiced. It is to be understood that other embodiments may be utilized and structural and functional modifications may be made without departing from the scope and spirit of the present invention.

As will be appreciated by one of skill in the art upon reading the following disclosure, various aspects described herein may be embodied as a method, a data processing system, or a computer program product. Accordingly, those aspects may take the form of an entirely hardware embodiment, an entirely software embodiment or an embodiment combining software and hardware aspects. Furthermore, such aspects may take the form of a computer program product stored by one or more computer-readable storage media having computer-readable program code, or instructions, embodied in or on the storage media. Any suitable computer readable storage media may be utilized, including hard disks, CD-ROMs, optical storage devices, magnetic storage devices, flash devices and/or any combination thereof.

In addition, various signals representing data or events as described herein may be transferred between a source and a destination in the form of electromagnetic waves traveling through signal-conducting media such as metal wires, optical fibers, and/or wireless transmission media (e.g., air and/or space).

For ease of reference, the following glossary provides definitions for the various abbreviations and notations used in this patent application:

DMN—Designated MSRP Node

ECL—Ethernet Convergence Layer

MAC—Media Access Controller—often a layer operated by a Media Access Controller in a transmission protocol which enables connectivity and addressing between physical devices

MPDU—MAC Protocol Data Unit

MSRP—Multicast Stream Reservation Protocol

MSRPDU—Multicast Stream Reservation Protocol Data Unit—a MSRP packet

NC—MoCA Network Controller

PHY—Physical Layer of MoCA Network

PLC—Power Line Communication, referring to a means of communicating via power lines—e.g., AC mains

SRP—Stream Reservation Protocol

TSPEC—Traffic SPECification

A first network system—e.g., an Ethernet based protocol may be bridged via a second network system. As an example, a MoCA network may support an advanced protocol for carrying multicast packets with Ethernet bridging. Such a MoCA network according to the invention preferably complies with the standard MoCA specifications, such as MoCA 2.0, and includes additional features that enable support of advanced protocol—e.g., IEEE 802.1Q REV 2010. Although the discussion below describes a solution for a MoCA network, any other suitable CSN network—e.g., PLC—are contemplated and included within the scope of the invention

The Multicast Stream Reservation Protocol (MSRP) is an extension of the Stream Reservation Protocol (SRP). MSRP is used by the IEEE standard 802.1Q standard which is one of the protocols of IEEE 802.1Audio Video Bridging (AVB) group of protocols. Multicasting is the transmission of information, often in packets, between a node and several nodes. Broadcasting is transmission of information, often in packets, between a node and all nodes. Transmission in either case may include transmission to the transmitting node.

Some types of Ethernet bridging are divided into a data plane and a control plane. The data plane is used to propagate data packets; the control plane handles control packets. Bridging of the data plane via a MoCA network may be straightforward. The ingress node of the MoCA network simple may look up the MAC address of the data packet—i.e., the destination address—in a routing table. If the MAC address is found, then the packet may be routed to the node(s) associated with the MAC address. If the routing table does not contain the MAC address the ingress node transmits the data packet to the other nodes—i.e., every node in the MoCA network with the exception of the ingress node. This process is termed “flooding” or broadcasting. The other nodes are preferably called egress nodes. The routing table may be updated by any suitable mechanism so as to minimize the number of packets that “flood” the bridge.

Control plane packets may be handled differently. Such packets may request resources or availability of other nodes in the network. The bridge itself, in some cases a MoCA network, should also have the resources to support the requested connection. Therefore, the control plane of the bridge may require knowledge of the request and knowledge of resource availability in the bridge.

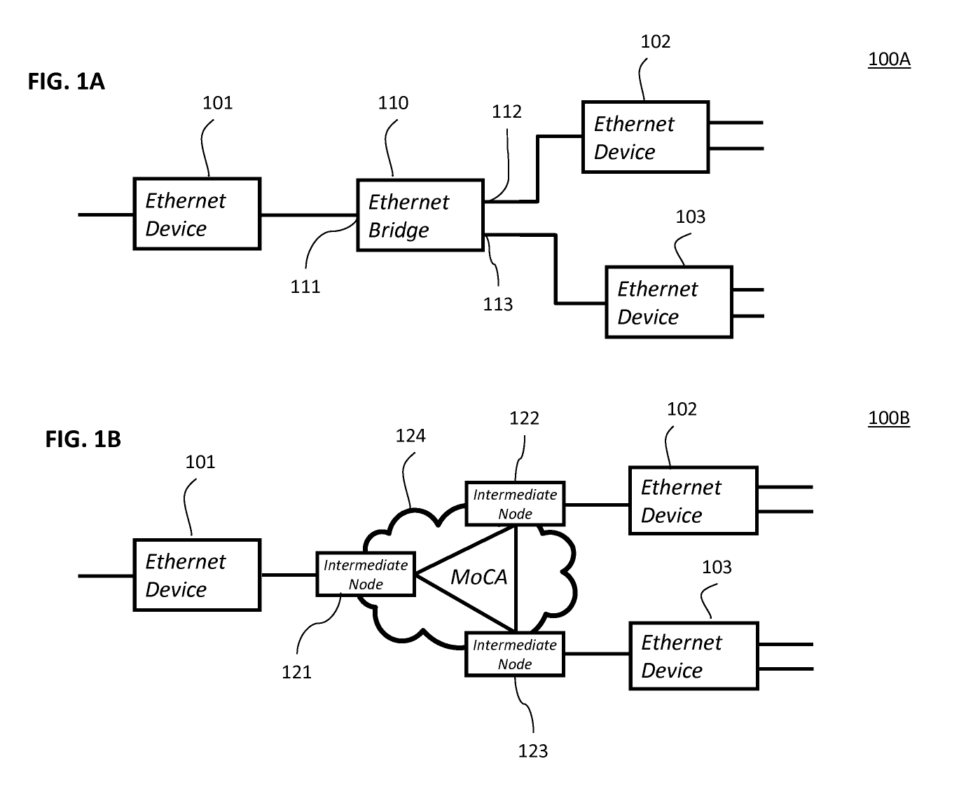

FIG. 1A is a schematic diagram of a network 100A which includes an Ethernet bridge 110. An Ethernet bridge may connect several Ethernet end-devices (leaf devices) and/or Ethernet bridges together so that packets may travel seamlessly to any connected Ethernet compliant equipment. Ethernet bridges may also connect Ethernet networks or Ethernet subnets, but this may not be preferred. Port 111 of Ethernet bridge 110 may be connected to a Ethernet device 101. Port 112 and port 113 of Ethernet bridge 110 may be connected to Ethernet device 102 and Ethernet device 103 respectively.

FIG. 1B is a schematic of a network 100B where a MoCA network 124 may emulate an Ethernet bridge—e.g., Ethernet bridge 110 of FIG. 1A. MoCA intermediate node 121 of MoCA network 124 may be connected to an Ethernet device 101. A MoCA intermediate node may include two ports, a MoCA port and a network port—e.g., an Ethernet port. MoCA intermediate node 122 and a MoCA intermediate node 123 of MoCA network 124 may be connected to Ethernet device 102 and Ethernet device 103, respectively. MoCA intermediate nodes 121, 122 and 123 may be connected to each other via MoCA network 124.

Establishing multicast connectivity under IEEE standard 802.1Q standard through an Ethernet bridge between Ethernet devices requires the routing of control packets through the Ethernet bridge. The control plane is the portion of the bridge that is concerned with handling the network control protocols carried by the control packets. Control plane logic also may define certain packets to be discarded, as well as giving preferential treatment to certain packets.

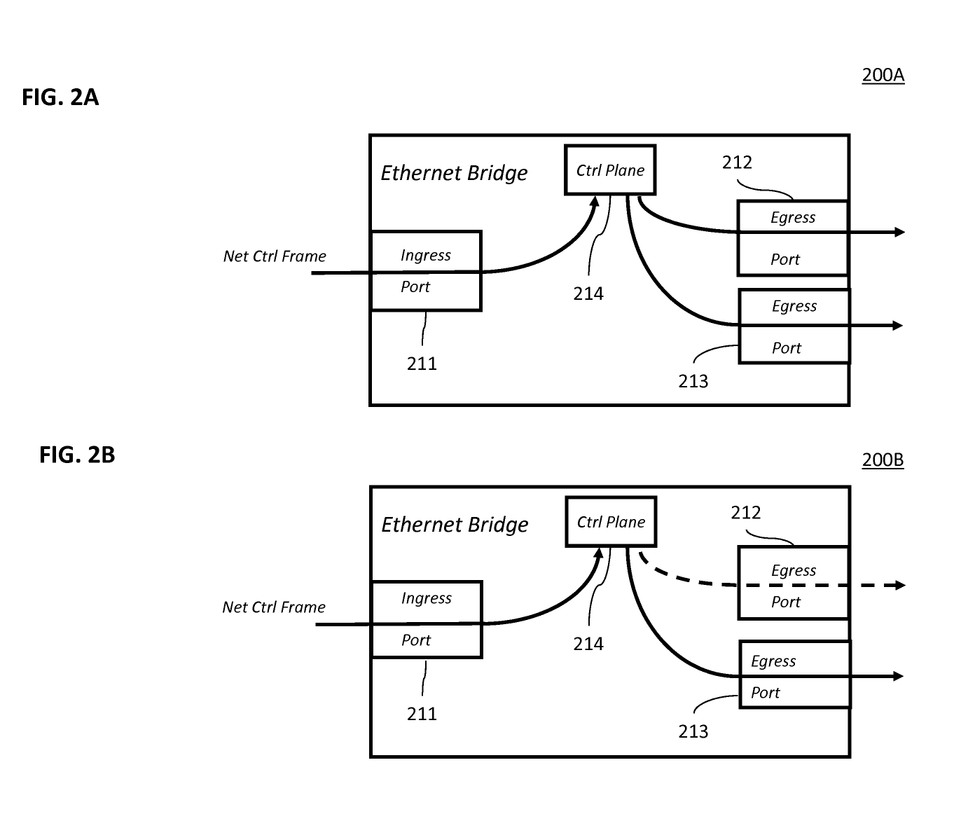

Broadcasting or “flooding” is one method of routing packets through an Ethernet bridge. This method may be used to send data packets through an Ethernet bridge. FIG. 2A shows a schematic of an Ethernet bridge 200A which may include ingress port 211, egress ports, 212 and 213 and a control plane 214. Ingress port 211 may receive a data packet, and send it to the control plane 214 of Ethernet bridge 200A. If the data packet is suitable for broadcasting then the data packet may be sent by the control plane 214 to all of the other ports on the bridge—i.e., port 212 and port 213.

Multicasting is another method of routing control packets through an Ethernet bridge. FIG. 2B is a schematic of an Ethernet bridge 200B which may include ingress port 211, egress ports, 212 and 213 and a control plane 214. Ingress port 211 may receive a network control frame and send it to the control plane 214 of Ethernet bridge 200B. A network control frame may also be referred to as a control packet. If the control packet is a multicast packet then that packet may be sent to some but not necessarily all of the other ports on the bridge—i.e., egress port 213 but not egress port 214. Alternately the control packet may be reformatted and different packets may be sent to different ports. A dashed line indicates that the packet sent from control plane 214 to egress port 212 is different than the packet sent from control plane 214 to egress port 213.

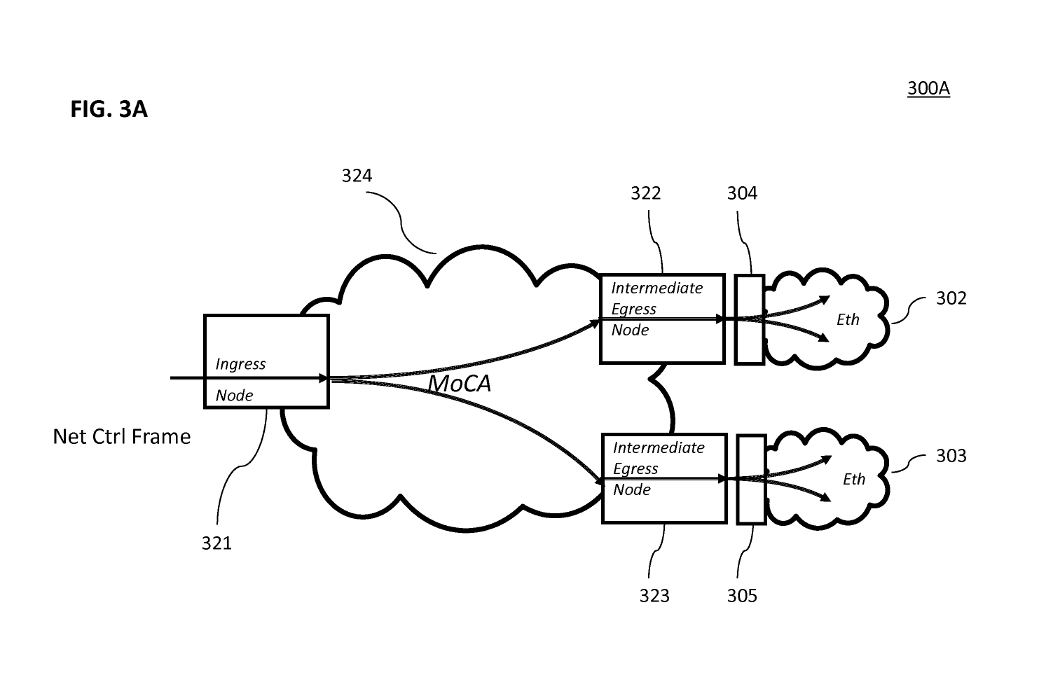

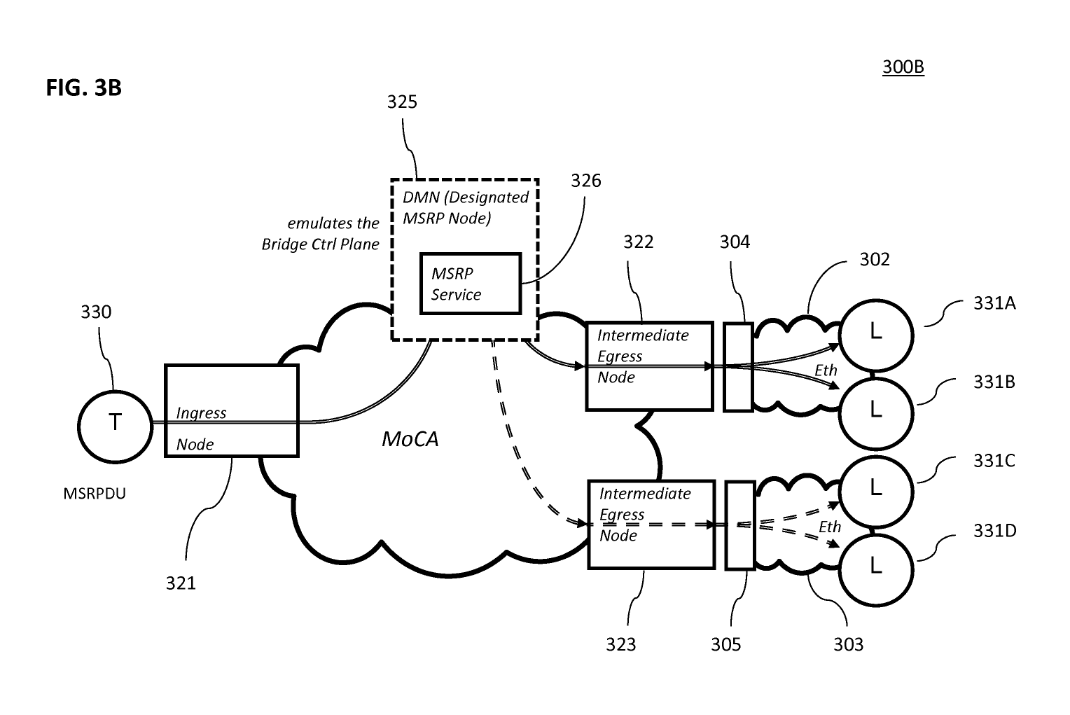

FIG. 3A illustrates an embodiment of the invention as a MoCA bridge 300A emulating an Ethernet bridge. MoCA bridge 300A may include ingress node 321, egress node 322 and egress node 323, all of which are preferably connected via a MoCA network 324. Ingress node 321 may receive a data packet. Ingress node 321 may route the data packet to an egress node if a routing table in the ingress node 321 has an entry for the MAC address of the data packet. If the routing table of ingress nodes 321 does not have an entry for the MAC address, then the ingress node 321 may send the data packet to all of the other nodes in the MoCA bridge 300A—e.g., egress node 322 and egress node 323. The “flooding” of the bridge 300A is illustrated in FIG. 3A by split lines from ingress node 321 to egress nodes 322 and 323.

Egress node 322 may send the data packet through optional interface 304 to Ethernet device 302. Egress node 323 may send the data packet through optional interface 305 to Ethernet device 303. If the Ethernet devices 302 and 303 are bridges then Ethernet devices 302, 303 may in turn broadcast—, i.e., flood—the data packet to all of the nodes in or connected to Ethernet devices 302, 303 as shown in FIG. 3A.

FIG. 3B illustrates another embodiment of the invention as a MoCA bridge 300B emulating the control plane of an Ethernet bridge. This embodiment may include all of the features of MoCA bridge 300A. The MoCA bridge 300B may include ingress node 321, intermediate egress node 322 and intermediate egress node 323, all of which are preferably connected via a MoCA network 324. Ingress node 321 may receive a Multicast Stream Reservation Protocol Data Unit (MSRPDU), e.g., a control packet, from Talker 330. In the alternative ingress nodes may generate the MSRPDU internally.

As described with respect to FIG. 2B a control packet is preferably routed to the control plane of the bridge 300B. Flooding, or broadcasting the control packet to all nodes may be ineffective as the control plane bridge preferably has knowledge of the resources requested of the bridge 300B by the control packet. Routing of the packet within a MoCA network may require an encapsulation into a MoCA frame (i.e. MoCA MAC Data Unit (MDU)) to assure proper transmission of the packet over the MoCA medium. It should be noted that a MoCA network is distributed, thus the control plane may be located in any node of the MoCA network. Preferably, the MAC address of the control plane node is known by every potential ingress node.

Ingress node 321 may route the control packet via MoCA network 324 to Designated MSRP Node (DMN) 325. A DMN node address may be located by the method specified in U.S. Patent No. 12/897,046, filed Oct. 4, 2010, entitled “Systems and Methods for Providing Service (“SRV”) Node Selection”, which is incorporated by reference herein in its entirety, or any other suitable method.

DMN 325 may include a MSRP service 326. MSRP service 326 may route the MSRPDU to a portion of the intermediate egress nodes of MoCA bridge network 324—i.e., intermediate egress node 322 as shown by the split line in FIG. 3B. Routing of the MSRPDU to intermediate egress node 322 may require addressing the control packet for intermediate egress node 322. Preferably an individually addressed MSRPDU is sent to every egress node as shown FIG. 3B by the dashed vs. solid split lines.

Intermediate egress node 322 may send the MSRPDU through optional interface 304 to Ethernet device 302. Intermediate egress node 323 may send the MSRPDU through optional interface 305 to Ethernet device 303. If the Ethernet devices 302 and 303 are bridges then Ethernet devices 302, 303 may in turn route the MSRPDU via their own control planes to all of the nodes in or connected to Ethernet devices 302, 303 as shown in FIG. 3B—e.g. Listener 331A, Listener 331B and Listener 331C, Listener 331D respectively.

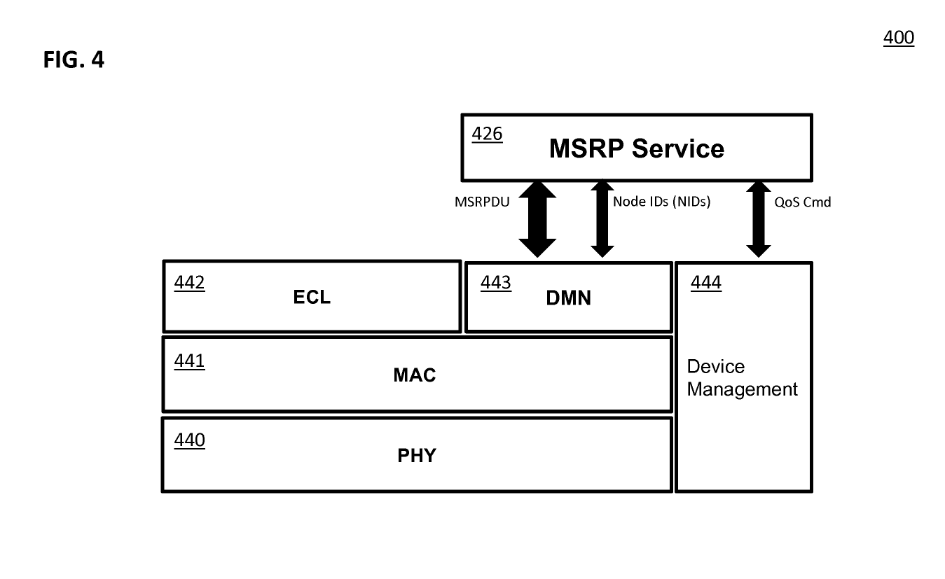

FIG. 4 is a schematic 400 of an embodiment of at least some of the network layers of a MoCA bridge which provides multicast services. MSRPDUs enter the MoCA bridge via Ethernet Convergence Layer (ECL) 442. The ECL layer 442 may repackage the MSPRDU for transit though the MoCA bridge at an ingress node—e.g., ingress node 321. The MSRPDU may be routed by MAC layer 441 and may be sent via PHY layer 440 to DMN layer 443 of the control plane node. DMN layer 443 may send the MSRPDU and node ID of the ingress node to MSRP service 426. MSRP service 426 may have knowledge of all nodes connect to the MoCA network. MSRP service 426 may repackage the MSRPDU for transit to some or all of nodes of the MoCA bridge and may send the MSRPDU and other node IDs to the DMN layer 443. The MSRP service 426 may also send Quality of Service (QoS) commands to the device management layer 444 of the MoCA bridge. The DMN layer 443 may address the repackaged MSRPDU to other nodes in the MoCA network. The repackaged MSRPDUs may then be routed by MAC layer 441 and may be sent via PHY layer 440 to an egress node(s) where the ECL layer 442 may unpack the MSRPDUs.

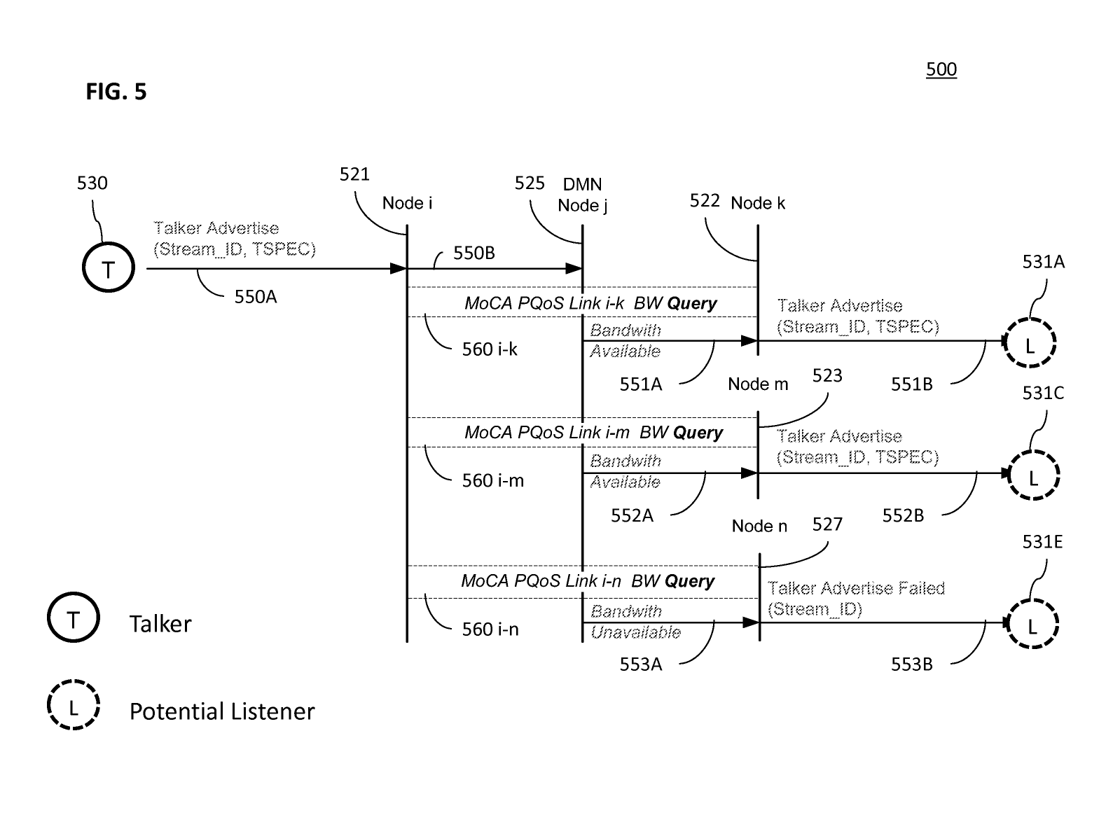

FIG. 5 is a schematic of an example 500 of the messaging implementing a protocol which processes a control packet requesting bandwidth for a stream. The bandwidth request may be processed by a MoCA network emulating an Ethernet bridge. The complete protocol may establish a stream. In example 500 a Talker 530 may send a Talker Advertise 550A to an ingress node 521 (Node i). A Talker Advertise—e.g., 550A—may include a Stream ID and a Transmission SPECification (TSPEC). Ingress node 521 may send a Talker Advertise 551B to DMN 525 (Node j). The DMN may implement a SRP and/or a MSRP as follows. In response to Talker Advertise 551, DMN 525 may query the availability of the bandwidth of the links between the Talker's ingress node (node i) 521 and all of the egress nodes by sending a bandwidth query 560 i-k to intermediate egress node 522 (node k), a bandwidth query 560 i-m to intermediate egress node 523 (node m) and a bandwidth query 560 i-n to intermediate egress node 527 (node n).

The bandwidth queries 560 are a translation of a bandwidth request in the control packet—i.e., an MSRP TSPEC—to a MoCA network request. This translation assures the management of bandwidth within the MoCA network which emulates the Ethernet bridge.

Although a translation to a MoCA bandwidth request is shown in example 500 other translations to other network requests are contemplated and included within the scope of the invention. Likewise, other types of requests—e.g., quality of service requests, loop protection etc.—are contemplated and included within the scope of the invention.

Where bandwidth is available a Talker Advertise may be sent to a Listener. When bandwidth is not available a Talker Advertise Failed may be sent to a Listener. In the example 500 the query 560 i-k is successful and a Talker Advertise 551A may be sent to intermediate egress node 522. Intermediate egress node 522 may send a Talker Advertise 551B to Listener 531A. Query 560 i-m is successful and a Talker Advertise 552A may be sent to intermediate egress node 523. Intermediate egress node 523 may send a Talker Advertise 552B to Listener 531C. Query 560 i-n is not successful and a Talker Advertise Failed 553A may be sent to intermediate egress node 527. Intermediate egress node 527 may send a Talker Advertise Failed 553B to Listener 531E. A Talker Advertise Failed may include a Stream_ID.

A stream allocation table may be created at the DMN node showing which Stream IDs have bandwidth available and which Stream_IDs have been established. The stream allocation table may include the TSPEC and the node connection—e.g., i connected to k, also called i-k—for each Stream_ID. The stream allocation table may also include failed connections. Entries in such a stream allocation table may be periodically removed or updated to prevent the accumulation of entries where one or both nodes have ended the Stream.

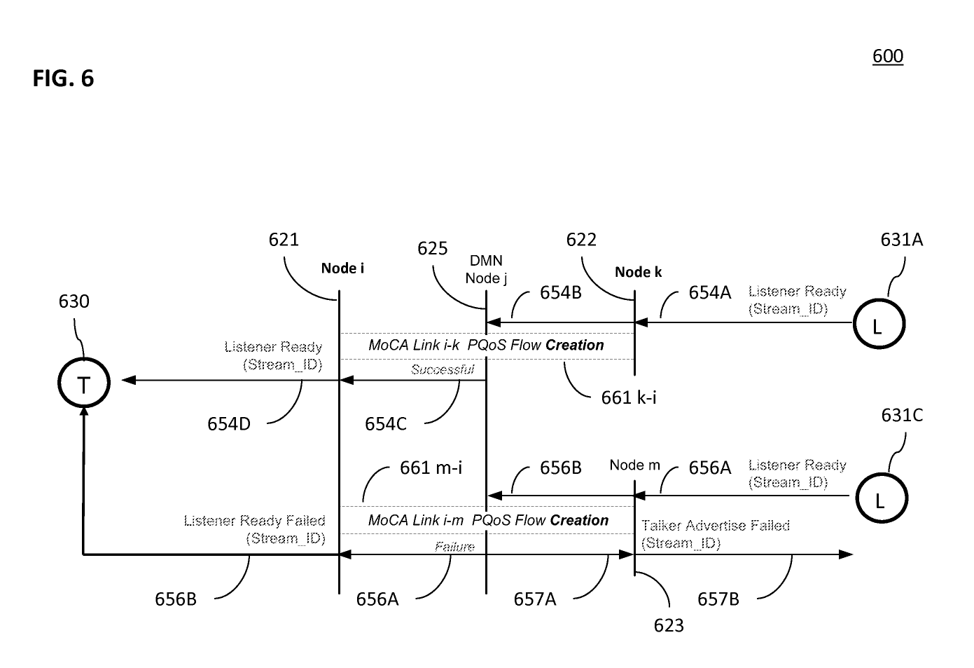

FIG. 6 is a schematic of an example 600 of the messaging implementing a protocol which processes a control packet for reserving bandwidth for a stream—i.e., the completion of example 500—which may finalize the bandwidth reservation and establish a MoCA flow. Listener 631A may send a Listener Ready 654A to intermediate egress node 622. Intermediate egress node 622 may send a Listener Ready 654B to DMN node 625. A Listener Ready—e.g., 650A—may include a Stream_ID. In response DMN 625 may establish a MoCA flow by sending a MoCA Flow Link Parameterized Quality of service (PQos) Flow Creation 661 k-i. If the Flow Creation is successful, DMN node 625 may send a Listener Ready 654C to ingress node 621. Ingress node 621 may send a Listener Ready 654D to Talker 630. The last step finalizes a path for packets through the MoCA bridge.

Listener 631C may send a Listener Ready 656A to intermediate egress node 623. Intermediate egress node 623 may send a Listener Ready 656B to DMN node 625. In response DMN 625 may establish a MoCA flow by sending a MoCA Flow Link PQos Flow Creation 661 m-i. If the Flow Creation fails, DMN node 625 may send a Listener Ready Failed 656A to ingress node 621 and Talker Advertise Failed 657A to intermediate egress node 623. Ingress node 621 may send a Listener Ready Failed 656B to Talker 630. Intermediate egress node 623 may send a Talker Advertise Failed 657B to Listener 631C. A Listener Ready Failed—e.g., 656B—may include a Stream ID. The stream allocation table may be updated after the processing of the MoCA Flow Creation results. The Stream_ID using the i-k route will be set to a status operational or any suitable equivalent state. The Stream_ID using the i-m route will be set to a status of non-operational or any suitable equivalent state. In the alternative, the table entry for the Stream_ID using the i-m route may be eliminated from the stream allocation table.

This failure may occur despite the availability previously reported by the bandwidth query—e.g., example 500. The failure may be caused by the loss of previously available bandwidth to other nodes or services during the protocol process.

The various steps shown in FIG. 5 and FIG. 6 may occur in any order except those steps that require a precursor step prior to activation—e.g., step 560 i-k, 560 i-m and 560 i-n may occur serially in any order or in parallel after step 550B. Steps that require a precursor step may not activate without the precursor step—e.g., step 551B cannot activate prior to the completion of step 551A.

Transmission of the various messages shown in FIG. 5 and FIG. 6 must be handled differently than ordinary MoCA packets. Ordinary treatment of MoCA messages is as follows. A MAC Unicast packet is transmitted as a MoCA unicast packet. A MAC Broadcast packet is transmitted as a MoCA broadcast packet. A MAC Multicast packet is generally transmitted as a MoCA broadcast packet but could also be transmitted as MAC unicast packets to each node members in the MAC Multicast group.

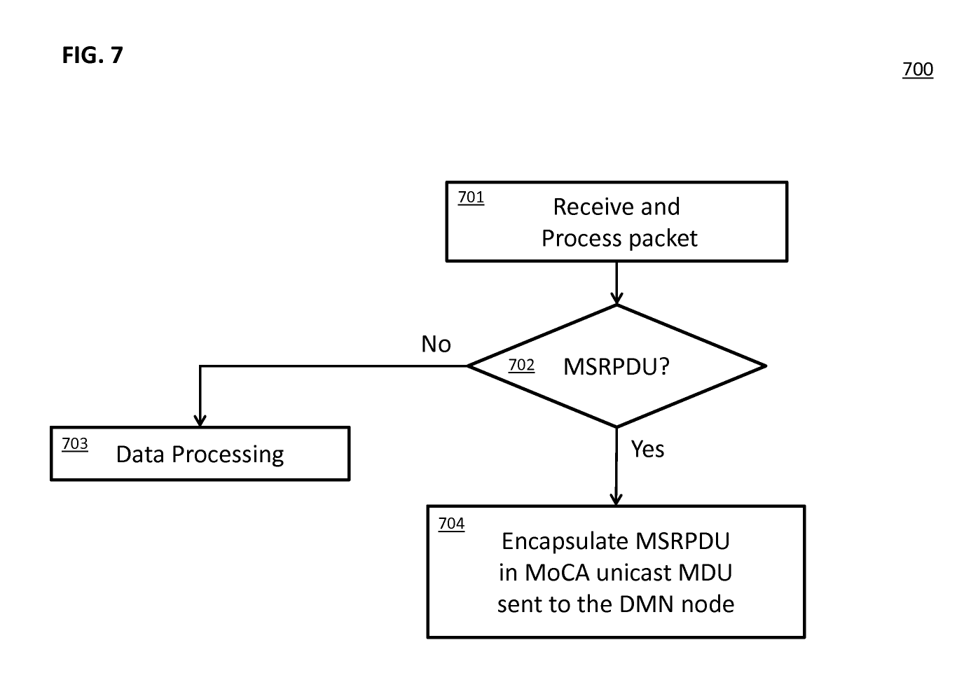

FIG. 7 is a flowchart 700 showing an embodiment of the steps for processing an Ethernet multicast control packet—e.g. a MSRPDU—by an ingress node—e.g., node 321. The ingress node processing may allow for transit of a control packet—e.g. a MSRPDU—through a MoCA network which may emulate an Ethernet bridge. At step 701 a packet may be received and processed. The packet may be a MSRPDU control packet. If so the MAC destination address may set the Nearest Bridge group address (01-80-C2-00-00-0E) as established by the IEEE 802.1Q specification or any other suitable address. Preferably the MSRPDU has its ethertype set appropriately—i.e., to 22-EA as established by the IEEE 802.1Q specification or any other suitable address. Checking the MAC destination address and the ethertype against suitable values may be used to identify a packet as a MSRPDU. At step 702, if the packet is not a MSRPDU then the packet may be processed as a data packet at step 703. If the packet is a MSRPDU, then the MSRPDU is preferably encapsulated as unicast MoCA packet at step 704. Encapsulation of the multicast MSRPDU sets the destination_node_ID to the individual_node_ID of the DMN—e.g., the address of the DMN 326. Then the packet is sent to the DMN. The packet may also identified as a control packet or a special control packet, to the MoCA network. The packet may be identified as a special control packet by the methods described in the MoCA specification or by any other suitable method.

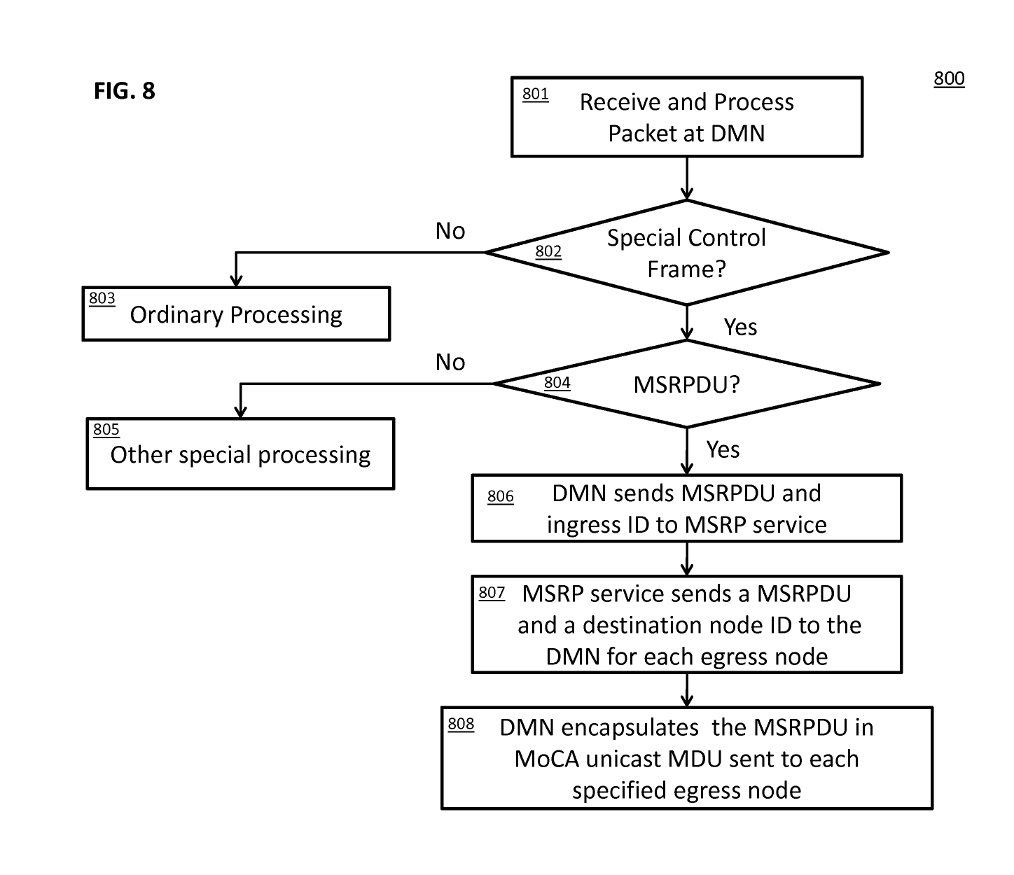

FIG. 8 is a flowchart 800 showing the steps for processing an Ethernet multicast packet—e.g., a MSRPDU—by a DMN—e.g., node 325. At step 801, a packet may be received and processed by the DMN. The packet may be the result of the processing shown in flow chart 700. The DMN may check if the packet is a special control frame at step 802. The packet may be identified as a special control packet by the methods described in the MoCA specification or by any suitable method. If the packet is not a special control frame then the packet is processed in an ordinary way at step 803.

If the packet is a special control frame then the DMN may check if the packet contains a MSRPDU at step 804. The MSRPDU may be identified as a Multicast Frame by comparing the MAC Destination Address with the Nearest Bridge group address and/or the ethertype. The Nearest Bridge group address may have the value of 01-80-C2-00-00-OE as established by the IEEE 802.1Q specification or any other suitable address. The ethertype may be set to 22-EA as established by the IEEE 802.1Q specification or any other suitable address.

If the packet does not contain a MSRPDU then the packet is processed as some other special control frame at step 805. If the packet does contain a MSRPDU then the MSRPDU and the ingress node ID are sent to the MSRP service—e.g., MSRP service 326 at step 806. Preferably, the ingress node ID is concatenated to the MSRPDU.

At step 807, the MSPR service sends a MSRPDU and a destination node ID to the DMN for each intermediate egress node in the MoCA network. Preferably, the intermediate egress node IDs are concatenated to the MSRPDUs. At step 808, the DMN creates and sends an encapsulated MSRPDU to each specified intermediate egress node in the MoCA network. Preferably, the MSRPDU is encapsulated as a unicast MoCA packet.

During the processing of flowcharts 700 and 800, the MSRPDU may remain unaltered at each processing stage. It is advantageous not to alter the MSRPDU because this reduces the complexity of the ingress nodes, the intermediate egress nodes and the DMN/MSRP service. In the alternative, the ingress node may alter the MSRPDU to aid the processing by the MoCA network or by the DMN. Likewise, the DMN may alter the MSRPDU to accommodate difference between the intermediate egress nodes or the Ethernet devices connected to the intermediate egress nodes.

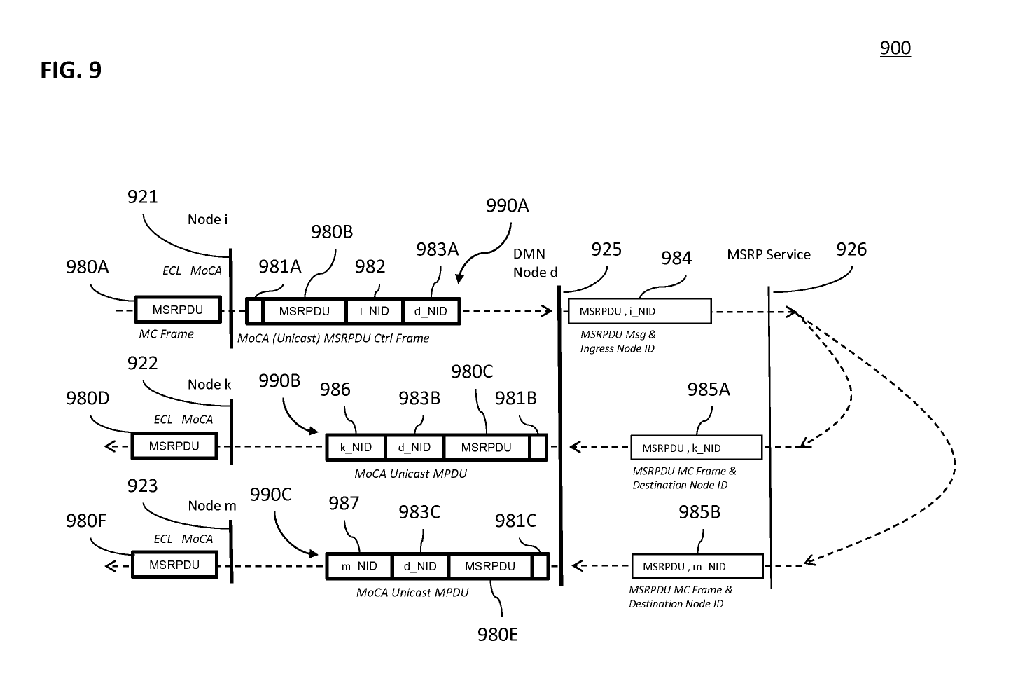

FIG. 9 is a schematic of packet processing showing the steps for the transit of an Ethernet multicast packet through a MoCA network which emulates an Ethernet bridge. A MSRPDU 980A may arrive at a intermediate egress node 921 (Node i). The MSRPDU 990A may be processed by an ECL layer—e.g., ECL layer 442. Ingress node 921 may proceed according the method described in flow chart 700. Ingress node 921 may create a unicast packet 990A. Unicast packet 990A is preferably a special control packet according to the MoCA specification. Unicast packet 990A may include a destination node ID 983A, a source node ID 982, a MSRPDU 980B and additional packet data 981A. Destination node ID 983A and source node ID 982 may be MAC address in accordance with the MoCA specification. Preferably destination node ID 983A is the address of the MoCA node which includes the DMN and the MSRP service for the control plane of the MoCA network.

DMN 925 may receive the unicast packet 990A. DMN 925 may process the unicast packet according to the method described in flow chart 800. As part of the processing of unicast packet 990A, DMN 925 may concatenate the source node ID 982 to the MSRPDU 980B to form intermediate packet 984. Intermediate packet 984 may be sent to MSRP service 926. MSRP service 926 may process intermediate packet according to the method described in flow chart 800. MSRP service 926 may process the MSRPDU according the SRP and/or the MSRP. MSRP service 926 may have knowledge of all nodes in the MoCA network. MSRP service 926 may create a list of intermediate egress nodes—i.e., every intermediate node in the MoCA network with the exception of the ingress node. As part of the processing of intermediate packet 984, MSRP service 926 may generate intermediate packets—e.g., 985A and 985B—for each intermediate egress node in the MoCA network. The intermediate packets 985A and 985B are sent to the DMN 925.

DMN 925 may receive the intermediate packets 985A and 985B. For each received intermediate packet the DMN may create a unicast packet—e.g., 990B and 990C. Unicast packet 990B may include a destination node ID 986, a source node ID 983B, a MSRPDU 980C and additional packet data 981B. Unicast packet 990C is preferably a MAC Protocol Data Unit (MPDU)—i.e., an ordinary unicast packet according to the MoCA specification. Unicast packet 990C may include a destination node ID 987, a source node ID 983C, a MSRPDU 980E and additional packet data 981C. Destination node IDs 986 and 987 and source node IDs 983B and 983C may be MAC address in accordance with the MoCA specification. Destination node ID 986 may be the address of intermediate egress node 922 (Node k). Destination node ID 987 may be the address of intermediate egress node 923 (Node m).

Intermediate egress node 922 may decapsulate the unicast packet 990B to extract MSRPDU 980C. The MSRPDU 990C may be processed by an ECL layer—e.g., ECL layer 442—to produce MSRPDU 980D. Intermediate egress node 923 may decapsulate the unicast packet 990E to extract MSRPDU 980E. The MSRPDU 990E may be processed by an ECL layer—e.g., ECL layer 442—to produce MSRPDU 980F.

During the processing shown by schematic 900 the MSRPDU 980A may remain unaltered at each processing stage—i.e., equivalent to MSRPDU 980B-980F. It is advantageous not to alter the MSRPDU since this reduces the complexity of the ingress nodes, the intermediate egress nodes and the DMN/MSPR service. In the alternative, the ingress node 921 may alter the MSRPDU 908A to aid processing by the MoCA network or by the DMN. Likewise the DMN may alter the MSRPDU 980B to accommodate differences between the intermediate egress nodes or the Ethernet devices connected to the intermediate egress nodes. Further processing of the MSRPDUs 980C and 980E may be performed by the intermediate egress nodes 922 and 923.

Any MoCA network in any of the figures or description above may be compliant with any MoCA specification including the MoCA 2.0 specification.

Although the diagrams show one ingress nodes and two egress nodes, other configurations including a multiple ingress nodes, a single egress node or more than two egress nodes are contemplated and included within the scope of the invention.

Thus, systems and methods for providing bridge emulation for Ethernet packets via a MoCA network or another suitable network has been provided.

Aspects of the invention have been described in terms of illustrative embodiments thereof. A person having ordinary skill in the art will appreciate that numerous additional embodiments, modifications, and variations may exist that remain within the scope and spirit of the appended claims. For example, one of ordinary skill in the art will appreciate that the steps illustrated in the figures may be performed in other than the recited order and that one or more steps illustrated may be optional. The methods and systems of the above-referenced embodiments may also include other additional elements, steps, computer-executable instructions, or computer-readable data structures. In this regard, other embodiments are disclosed herein as well that can be partially or wholly implemented on a computer-readable medium, for example, by storing computer-executable instructions or modules or by utilizing computer-readable data structures.

What is claimed is:

1. A method for bridging a packet of a first network via a second network, wherein the first network comprises a first node and wherein the second network comprises an ingress node and a first egress node, wherein the first egress node is connected to the first node, the method comprising:
receiving the packet of the first network at the ingress node;
encapsulating the packet of the first network into a first packet of the second network at the ingress node;
transmitting the first packet of the second network to a control plane node;
decapsulating the first packet of the second network to extract the packet of the first network at the control plane node;
encapsulating the packet of the first network into a second packet of the second network at the control plane node;
transmitting the second packet of the second network to the first egress node;
decapsulating the second packet of the second network to extract the packet of the first network at the first egress node; and
transmitting the packet of the first network to the first node.

2. The method of claim 1 wherein the first network comprises a second node, wherein the second node transmits the packet to the ingress node.

3. The method of claim 1 further comprising determining if the packet is a control packet at the ingress node.

4. The method of claim 3 further comprising marking the first packet of the second network as a control packet according to the second network.

5. The method of claim 3 wherein the first packet of the second network comprises the address of the control plane node.

6. The method of claim 3 wherein the first packet of the second network comprises the address of the ingress node.

7. The method of claim 6 further comprising extracting the address of the ingress node from the first packet of the second network.

8. The method of claim 7 further comprising determining the address of the first egress ingress node.

9. The method of claim 1 wherein the second network comprises at least one second egress node(s), the method further comprising determining the address of the first egress ingress node and at least one of the second egress node(s).

10. The method of claim 1 wherein the second packet of the second network comprises the address of the egress node.

11. The method of claim 1 wherein the second network comprises at least one second egress node(s), wherein the second packet of the second network comprises the address of the egress node and at least one third packet comprises the address of at least one of the second egress node(s).

12. The method of claim 1 further comprising extracting a requirement for a network resource from the packet at the control plane node.

13. The method of claim 12 further comprising determining the availability of the network resource according to the requirement at the control plane node.

14. The method of claim 13 further comprising transmitting the second packet of the second network to the first egress node when the network resource is available.

15. The method of claim 13 further comprising transmitting a failure message to the first egress node when the network resource is not available.

16. The method of claim 1 wherein the first network is an Ethernet network.

17. The method of claim 1 wherein the first network is an Ethernet network implementing the Institute for Electrical and Electronics Engineers 802.1Q protocol.

18. The method of claim 1 wherein the second network is a MoCA network.

19. The method of claim 1 wherein the second network is a Power Line Communication network.

20. A method for bridging a packet of a first network via a second network, wherein the first network comprises a first node and a second node and wherein the second network comprises a ingress node and a first egress node, wherein the ingress node is connected to the second node and the first egress node is connected to the second node, the method comprising:
receiving the packet of the first network at the first egress node from the first node;
encapsulating the packet of the first network into a first packet of the second network at the egress node;
transmitting the first packet of the second network to a control plane node;
decapsulating the first packet of the second network to extract the packet of the first network at the control plane node;
encapsulating the packet of the first network into a second packet of the second network at the control plane node;
transmitting the second packet of the second network to the ingress node;
decapsulating the second packet of the second network to extract the packet of the first network at the ingress node; and
transmitting the packet of the first network to the second node.

21. The method of claim 20 further comprising determining if the packet is a control packet at the first egress node.

22. The method of claim 21 further comprising marking the first packet of the second network as a control packet according to the second network.

23. The method of claim 21 wherein the first packet of the second network comprises the address of the first egress node.

24. The method of claim 21 wherein the first packet of the second network comprises the address of the control plane node.

25. The method of claim 24 further comprising extracting the address of the first egress node from the first packet of the second network.

26. The method of claim 24 further comprising determining the address of the first egress node.

27. The method of claim 24 further comprising determining the address of the ingress node from the first packet of the second network.

28. The method of claim 20 wherein the second packet of the second network comprises the address of the ingress node.

29. The method of claim 20 further comprising extracting a requirement for a network resource from the packet at the control plane node.

30. The method of claim 29 further comprising confirming the availability of the network resource according to the requirement at the control plane node.

31. The method of claim 30 further comprising transmitting the second packet of the second network to the ingress node when the network resource is available.

32. The method of claim 30 further comprising transmitting a failure message to the first egress node when the network resource is not available.

33. The method of claim 30 further comprising transmitting a failure message to the ingress node when the network resource is not available.

34. The method of claim 20 wherein the first network is an Ethernet network.

35. The method of claim 20 wherein the first network is an Ethernet network implementing the Institute for Electrical and Electronics Engineers 802.1Q protocol.

36. The method of claim 20 wherein the second network is a MoCA network.

37. The method of claim 20 wherein the second network is a Power Line Communication network.

38. A control plane node for use with a network system, the network system comprising a first network having a first node, and a second network having an ingress node and a egress node, wherein, a packet according to the first network is received by the ingress node, encapsulated by the ingress node into a first packet according to the second network and sent by the ingress node to the control plane node, the control plane node configured to:
decapsulate the first packet according to the second network;
retrieve the packet;
encapsulate the packet into a second packet according to the second network; and
send the second packet to the egress node.

39. The control plane node of claim 38 wherein the first network comprises a second node, wherein the second node is configured to send the packet to the ingress node.

40. A control plane node for use with a network system, the network system comprising a first network having a first node, and a second network having an ingress node and a egress node, wherein, a packet of the first network is received at the first egress node from the first node, encapsulated into a first packet of the second network at the egress node, transmitted to the control plane node, the control plane node configured to:
decapsulate the first packet of the second network to extract the packet of the first network;
encapsulate the packet of the first network into a second packet of the second network; and
transmit the second packet of the second network to the ingress node;
wherein the ingress node is configured to decapsulate the second packet of the second network to extract the packet of the first network and transmit the packet of the first network to the second node.
